(19) United States
(12) Patent Application Publication
(10) Pub. No.: US 2021/0392907 A1
(43) Pub. Date: Dec. 23, 2021

(54) METHOD FOR PRODUCING BAKERY FOOD

(71) Applicant: J-OIL MILLS, INC., Tokyo (JP)

(72) Inventors: Ayu MARUI, Tokyo (JP); Yuya NAGAHATA, Tokyo (JP); Daisuke NAGASAWA, Tokyo (JP)

(21) Appl. No.: 17/295,249

(22) PCT Filed: Nov. 21, 2019
(86) PCT No.: PCT/JP2019/045684

§ 371 Date: May 19, 2021

(30) Foreign Application Priority Data
Nov. 30, 2018 (JP) 2018-226093

(51) Int. Cl. A21D 2/18; A21D 2/16; A21D 13/41; A21D 13/60; A21D 8/02

(52) U.S. Cl. CPC A21D 2/186; A21D 2/165; A21D 8/02; A21D 13/60; A21D 13/41

(57) ABSTRACT

Disclosed is a method for producing a bakery food, the method including preparing a bakery dough containing: an edible fat or oil composition including an edible fat or oil having a solid fat content at 20° C. of equal to or less than 5%; and a component (A) satisfying condition (1) a starch content is equal to or more than 75% by mass, condition (2) a low molecular weight starch obtained from a starch having an amylose content of equal to or more than 5% by mass is included, a content of the low molecular weight starch being equal to or more than 3% by mass and equal to or less than 45% by mass, and the low molecular-weight starch has a peak molecular weight of equal to or more than 3×10³ and equal to or less than 5×10⁴, condition (3) degree of swelling in cold water at 25° C. is equal to or higher than 5 and equal to or lower than 20, and condition (4) a content of particles passing through a sieve having an opening of 0.5 mm and remaining on a sieve having an opening of 0.038 mm is equal to or more than 30% by mass and equal to or less than 100% by mass, in which in the preparing a bakery dough, the content of the component (A) in the bakery dough is equal to or more than 0.5% by mass and equal to or less than 30% by mass with respect to the total content of a powder raw material, and the content of the component (A) with respect to the content of the edible fat or oil composition in the bakery dough is equal to or more than 0.03 and equal to or less than 8.0 as a mass ratio.

### TECHNICAL FIELD

The present invention relates to a method for producing a bakery food.

### BACKGROUND ART

Conventionally, in a case where a fat or oil is blended into a bakery food such as bread, fats and oils that are solid at ordinary temperature, such as butter, margarine, and shortening, have been used. In recent years, in view of growing health consciousness and diversity of tastes, there is an expectation for a technology for blending fats and oils that are liquid at ordinary temperature, such as sesame oil and olive oil, into bakery foods. However, generically in the case of bakery foods, especially bread, it is considered that fats and oils that are liquid at ordinary temperature hinder the formation of gluten, and there are occasions in which bread does not swell sufficiently and the mouthfeel is hard, or a finished bread feels sticky.

As a technology for blending a fat or oil that is liquid at ordinary temperature into a dough of a bakery food, the technology described in Patent Document 1 is available.

Patent Document 1 discloses a fat or oil composition for a bakery product in which liquid oil is used as a main raw material while a thickening polysaccharide as a moisturizer is fixedly dispersed by an emulsifier, and it is considered that by adding this fat or oil composition for a bakery product, an effect of suppressing aging prevention in the bakery product can be exhibited and the melt-in-the-mouth sensation can be enhanced.

### RELATED DOCUMENT

### Patent Document

[Patent Document 1] Japanese Unexamined Patent Publication No. 2005-000048

### SUMMARY OF INVENTION

### Technical Problem

However, Patent Document 1 neither discloses nor suggests a means for reducing stickiness and hardness in the mouthfeel of a bakery food in a case where a starch composition is used in combination with fats and oils that are liquid at ordinary temperature.

### Solution to Problem

Thus, the inventors of the present invention conducted a thorough investigation, and as a result, the inventors found that with regard to a bakery food to which a fat or oil that is liquid at ordinary temperature is added, a bakery food having reduced stickiness, an excellent melt-in-the-mouth feeling, satisfactory easiness to bite, and a soft feeling is obtainable by incorporating a specific component into the dough, thus completing the present invention.

That is, according to the present invention, there is provided a method for producing a bakery food, the method including preparing a bakery dough containing an edible fat or oil composition including an edible fat or oil having a solid fat content at 20° C. of equal to or less than 5%, and a component (A) satisfying the following conditions (1) to (4),

in which in the preparing a bakery dough,

a content of the component (A) in the bakery dough is equal to or more than 0.5% by mass and equal to or less than 30% by mass with respect to a total content of a powder raw material, and

a content of the component (A) with respect to a content of the edible fat or oil composition in the bakery dough is equal to or more than 0.03 and equal to or less than 8.0 as a mass ratio:

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of particles passing through a sieve having an opening of 0.5 mm and remaining on a sieve having an opening of 0.038 mm is equal to or more than 30% by mass and equal to or less than 100% by mass.

It is preferable that method for producing a bakery food further includes heating cooking the bakery dough.

It is preferable that a method for the heating cooking is baking or deep frying.

The bakery food is preferably one selected from the group consisting of bread, pizza, and doughnut.

It is preferable that a content of particles passing through a sieve having an opening of 0.25 mm and remaining on a sieve having an opening of 0.038 mm in the component (A) is equal to or more than 20% by mass and equal to or less than 100% by mass.

It is preferable that the dough contains grain flour.

It is preferable that a solid fat content at 10° C. of the edible fat or oil in the edible fat or oil composition is equal to or less than 5%.

It is preferable that the content of the edible fat or oil composition is equal to or more than 2% by mass and equal to or less than 45% by mass with respect to the total content of the powder raw material.

Furthermore, according to the present invention, there is provided a bakery dough containing an edible fat or oil composition including an edible fat or oil having a solid fat content at 20° C. of equal to or less than 5%, and a component (A) satisfying the following conditions (1) to (4),

in which a content of the component (A) in the bakery dough is equal to or more than 0.5% by mass and equal to or less than 30% by mass with respect to a total content of a powder raw material, and

a content of the component (A) with respect to a content of the edible fat or oil composition in the bakery dough is equal to or more than 0.03 and equal to or less than 8.0 as a mass ratio:

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of particles passing through a sieve having an opening of 0.5 mm and remaining on a sieve having an opening of 0.038 mm is equal to or more than 30% by mass and equal to or less than 100% by mass.

Furthermore, according to the present invention,

there is provided a method for enhancing easiness to bite a bakery food which is obtainable by heating cooking a bakery dough blended with an edible fat or oil composition including an edible fat or oil having a solid fat content at 20° C. of equal to or less than 5%,

in which a component (A) satisfying the following conditions (1) to (4) is blended into the bakery dough,

a blending amount of the component (A) in the dough of the bakery food is equal to or more than 0.5% by mass and equal to or less than 30% by mass with respect to a total blending amount of a powder raw material, and

the blending amount of the component (A) with respect to a blending amount of the edible fat or oil composition in the bakery dough is equal to or more than 0.03 and equal to or less than 8.0 as a mass ratio:

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of particles passing through a sieve having an opening of 0.5 mm and remaining on a sieve having an opening of 0.038 mm is equal to or more than 30% by mass and equal to or less than 100% by mass.

Any combination of these various configurations and conversions of the expressions of the present invention in different methods, devices, and the like are also effective as embodiments of the present invention.

For example, according to the present invention, a processed food that uses a bakery food obtainable by the production method according to the present invention is provided.

### Advantageous Effects of Invention

According to the present invention, a bakery food that has reduced stickiness, an excellent melt-in-the-mouth feeling, satisfactory easiness to bite, and a soft feeling can be obtained. Meanwhile, the term stickiness as used herein means a condition in which when eating, food is mixed with saliva in the mouth and becomes gooey. Furthermore, an excellent melt-in-the-mouth feeling means a state in which when eating, food does not stay in a dumpling form in the mouth but easily crumbles and melts.

### DESCRIPTION OF EMBODIMENTS

Hereinafter, embodiments of the present invention will be described with reference to specific examples of various components. Incidentally, all the components can be each used alone or in combination of two or more kinds thereof.

(Bakery Dough)

In the present embodiment, bakery dough (hereinafter, also referred to as “dough for bakery”) contains an edible fat or oil composition including an edible fat or oil having a solid fat content at 20° C. of equal to or less than 5%, and a component (A) satisfying conditions (1) to (4),

the blending amount of the component (A) in the bakery dough is equal to or more than 0.5% by mass and equal to or less than 30% by mass with respect to the total blending amount of the powder raw material, and

the blending amount of the component (A) with respect to the blending amount of the edible fat or oil composition is equal to or more than 0.03 and equal to or less than 8.0 as a mass ratio.

Component (A): (1) the starch content is equal to or more than 75% by mass,

(2) a low molecular-weight starch obtained from a starch having an amylose content of equal to or more than 5% by mass is included, the amount of the low molecular weight starch being equal to or more than 3% by mass and equal to or less than 45% by mass,

the peak molecular weight of the low molecular weight starch is equal to or more than 3×10³ and equal to or less than 5×10⁴,

(3) the degree of swelling in cold water at 25° C. is equal to or higher than 5 and equal to or lower than 20, and

(4) a content of particles passing through a sieve having an opening of 0.5 mm and remaining on a sieve having an opening of 0.038 mm is equal to or more than 30% by mass and equal to or less than 100% by mass.

Hereinafter, various components that are raw materials of the bakery dough will be described.

(Component (A))

The component (A) is a starch composition including equal to or more than 75% by mass of starch. The component (A) includes equal to or more than 3% by mass and equal to or less than 45% by mass of a low molecular weight starch obtained from a starch having an amylose content of equal to or more than 5% by mass as starch in the starch composition, the peak molecular weight of the low molecular weight starch is equal to or more than 3×10³ and equal to or less than 5×10⁴, and the degree of swelling in cold water of the starch composition at 25° C. is equal to or higher than 5 and equal to or lower than 20. The content of particles passing through a sieve having an opening of 0.5 mm and remaining on a sieve having an opening of 0.038 mm in the component (A) is equal to or more than 30% by mass and equal to or less than 100% by mass with respect to the total amount of the component (A).

Hereinafter, the component (A) will be described more specifically.

The content of starch in the component (A) is equal to or more than 75% by mass from the viewpoint of reducing stickiness and enhancing the melt-in-the-mouth feeling, easiness to bite, and soft feeling, and it is preferable to adjust the content to be equal to or more than 80% by mass, while it is more preferable to adjust the content to be equal to or more than 85% by mass.

The upper limit of the starch content in the component (A) is not limited and is equal to or less than 100% by mass; however, the upper limit may also be, for example, equal to or less than 99.5% by mass or equal to or less than 99% by mass, according to the properties of the bakery food and the like.

Here, the content of starch in the component (A) is the content with respect to the total amount of the component (A).

Furthermore, the component (A) includes, as the starch, a specific proportion of a low molecular weight starch produced from a starch having an amylose content of equal to or more than 5% by mass as a raw material, and as the low molecular weight starch, a low molecular weight starch having a specific peak molecular weight is used. That is, the starch in the component (A) includes equal to or more than 3% by mass and equal to or less than 45% by mass of a low molecular weight starch produced from a starch having an amylose content of equal to or more than 5% by mass in the component (A), and the peak molecular weight of the low molecular weight starch is equal to or more than 3×10³ and equal to or less than 5×10⁴.

The peak molecular weight of the low molecular weight starch is equal to or more than 3×10³, and it is preferable to adjust the peak molecular weight to be equal to or more than 8×10³, from the viewpoint of reducing stickiness and enhancing the melt-in-the-mouth feeling, easiness to bite, and soft feeling. Furthermore, the peak molecular weight of the low molecular weight starch is equal to or less than 5×10⁴, and it is preferable to adjust the peak molecular weight to be equal to or less than 3×10⁴, and more preferably to be equal to or less than 1.5×10⁴, from the viewpoint of enhancing the melt-in-the-mouth feeling. The method for measuring the peak molecular weight of starch after degradation will be described in the section of Examples.

From the viewpoint of having excellent production stability, the low molecular weight starch is preferably one kind or two or more kinds selected from the group consisting of an acid-treated starch, an oxidation-treated starch, and an enzyme-treated starch, and the low molecular weight starch is more preferably an acid-treated starch.

The conditions for an acid treatment are not limited; however, the treatment can be carried out, for example, as follows.

A starch having an amylose content of equal to or more than 5% by mass and water are introduced into a reactor, and an acid is further introduced. Alternatively, acid water obtained by dissolving an acid in advance in water and starch as a raw material are introduced into a reactor. From the viewpoint of performing the acid treatment more stably, it is desirable that the total amount of starch in the reaction is in a state of being homogeneously dispersed in an aqueous phase, or in a slurrified state. Thus, the concentration of the starch slurry for performing the acid treatment is adjusted to be in the range of, for example, equal to or more than 10% by mass and equal to or less than 50% by mass, and preferably equal to or more than 20% by mass and equal to or less than 40% by mass. When the slurry concentration is too high, the slurry viscosity may increase, and uniform stirring of the slurry may be difficult.

Specific examples of the acid to be used for the acid treatment include inorganic acids such as hydrochloric acid, sulfuric acid, and nitric acid, which can be utilized regardless of the type, purity, and the like.

With regard to the acid treatment reaction, for example, the acid concentration employed during the acid treatment is preferably equal to or higher than 0.05 Normality (N) and equal to or lower than 4 N, more preferably equal to or higher than 0.1 N and equal to or lower than 4 N, and even more preferably equal to or higher than 0.2 N and equal to or lower than 3 N. The reaction temperature is preferably equal to or higher than 30° C. and equal to or lower than 70° C., more preferably equal to or higher than 35° C. and equal to or lower than 70° C., and even more preferably equal to or higher than 35° C. and equal to or lower than 65° C. The reaction time is preferably equal to or more than 0.5 hours and equal to or less than 120 hours, more preferably equal to or more than 1 hour and equal to or less than 72 hours, and even more preferably equal to or more than 1 hour and equal to or less than 48 hours.

The content of the low molecular weight starch in the component (A) is equal to or more than 3% by mass with respect to the total amount of the component (A) from the viewpoint of reducing stickiness and enhancing the melt-in-the-mouth feeling, easiness to bite, and soft feeling, and the content is preferably equal to or more than 8% by mass and is more preferably adjusted to be equal to or more than 13% by mass.

On the other hand, from a similar point of view, the content of the low molecular weight starch in the component (A) is equal to or less than 45% by mass with respect to the total amount of the component (A), and the content is preferably equal to or less than 35% by mass and is more preferably adjusted to be equal to or less than 25% by mass.

Here, the content of the low molecular weight starch in the component (A) is the content with respect to the total amount of the component (A).

The amylose content in the raw material starch for the low molecular weight starch is equal to or more than 5% by mass, preferably equal to or more than 12% by mass, more preferably equal to or more than 22% by mass, even more preferably equal to or more than 45% by mass, still more preferably equal to or more than 55% by mass, and most preferably equal to or more than 65% by mass. The upper limit of the amylose content in the raw material starch for the low molecular weight starch is not limited, and the upper limit is equal to or less than 100% by mass, preferably equal to or less than 90% by mass, and more preferably equal to or less than 80% by mass.

As the starch having an amylose content of equal to or more than 5% by mass, which is a raw material for the low molecular weight starch, any one kind or two or more kinds selected from the group consisting of high amylose cornstarch, cornstarch, tapioca starch, sweet potato starch, potato starch, wheat starch, high amylose wheat starch, rice starch, and processed starches obtained by chemically, physically, or enzymatically processing these raw materials, can be used. From the viewpoint of reducing stickiness and enhancing the melt-in-the-mouth feeling, easiness to bite, and soft feeling, it is preferable to use one kind or two or more kinds selected from high amylose cornstarch, cornstarch, and tapioca starch, and it is more preferable to use high amylose cornstarch. Regarding the amylose content of the high amylose cornstarch, cornstarches having an amylose content of equal to or more than 40% by mass are available. The starch having an amylose content of equal to or more than 5% by mass is more preferably a cornstarch having an amylose content of equal to or more than 40% by mass.

The degree of swelling in cold water at 25° C. of the component (A) is equal to or higher than 5, preferably equal to or higher than 5.5, and more preferably equal to or higher than 6, from the viewpoint of reducing stickiness and enhancing the melt-in-the-mouth feeling, easiness to bite, and soft feeling.

From a similar point of view, the degree of swelling in cold water at 25° C. of the component (A) is equal to or lower than 20, preferably equal to or lower than 17, and more preferably equal to or lower than 15.

Here, the degree of swelling in cold water swelling at 25° C. of the component (A) is measured by the following method.

(1) A sample is heated and dried at 125° C., the moisture content is measured using a moisture meter (manufactured by Kensei Kogyo Co., Ltd., model number MX-50), and the dry mass is calculated from the moisture content value thus obtained.

(2) 1 g of the sample in terms of this dry mass is dispersed in 50 mL of water at 25° C., the dispersion is stirred gently in a constant temperature bath at 25° C. for 30 minutes, and then the dispersion is centrifuged (centrifugal separator: manufactured by Hitachi Koki Co., Ltd., Hitachi Tabletop Centrifuge CT6E type; rotor: T4SS type swing rotor; adapter: 50TC×2S adapter) at 3000 rpm for 10 minutes to be separated into a sediment layer and a supernatant layer.

(3) The supernatant layer is removed, the mass of the sediment layer is measured, and this is designated as B (g).

(4) The mass obtained when the sediment layer is solid-dried (105° C., constant weight) is designated as C (g).

(5) The value obtained by dividing B by C is defined as the degree of swelling in cold water.

The content of particles passing through a sieve having an opening of 0.5 mm and remaining on a sieve having an opening of 0.038 mm according to the JIS-Z8801-1 standard in the component (A) is equal to or more than 30% by mass and equal to or less than 100% by mass, and from the viewpoint of reducing stickiness and enhancing the melt-in-the-mouth feeling, easiness to bite, and soft feeling, the content is preferably equal to or more than 40% by mass and equal to or less than 100% by mass, more preferably equal to or more than 50% by mass and equal to or less than 100% by mass, and even more preferably equal to or more than 65% by mass and equal to or less than 100% by mass.

Furthermore, from the viewpoint of enhancing the melt-in-the-mouth feeling, the content of particles passing through a sieve having an opening of 0.25 mm and remaining on a sieve having an opening of 0.038 mm among the sieves according to the JIS-Z8801-1 standard in the component (A) is preferably equal to or more than 20% by mass and equal to or less than 100% by mass, more preferably equal to or more than 25% by mass and equal to or less than 100% by mass, even more preferably equal to or more than 28% by mass and equal to or less than 100% by mass, and still more preferably equal to or more than 30% by mass and equal to or less than 100% by mass.

From the viewpoint of enhancing the melt-in-the-mouth feeling, the content of particles passing through a sieve having an opening of 0.15 mm and remaining on a sieve having an opening of 0.038 mm among the sieves according to the JIS-Z8801-1 standard in the component (A) is preferably equal to or more than 10% by mass and equal to or less than 100% by mass, more preferably equal to or more than 12% by mass and equal to or less than 100% by mass, even more preferably equal to or more than 15% by mass and equal to or less than 100% by mass, and still more preferably equal to or more than 17% by mass and equal to or less than 100% by mass.

Here, the content of particles below or above a predetermined sieve in the component (A) is the content of a fraction of the particles below or above a predetermined sieve with respect to the total amount of the component (A) when the component (A) is passed through the predetermined sieve.

According to the present embodiment, various starches can be used as a starch component other than the low molecular weight starch in the component (A). Specifically, any starch that is generally commercially available according to intended uses, for example, starch for foods, may be used regardless of the type; however, any one or more can be appropriately selected from starches such as cornstarch, potato starch, tapioca starch, and wheat starch; processed starches obtained by chemically, physically, or enzymatically processing these starches; and the like. Preferably, the component (A) may contain one kind or two or more kinds of starches selected from the group consisting of cornstarch, wheat starch, potato starch, tapioca starch, and cross-linked starches of these, and more preferably, the component (A) may contain cornstarch.

Furthermore, the component (A) according to the present embodiment may also be blended with components other than starch.

Specific examples of the components other than starch include insoluble salts such as calcium carbonate and calcium sulfate; and colorants, and it is preferable to blend an insoluble salt, while it is more preferable that the blending amount of the insoluble salt is equal to or more than 0.1% by mass and equal to or less than 2% by mass.

Next, a method for producing the component (A) will be described. The method for producing the component (A) includes, for example, the following steps.

(Preparing low molecular weight starch) A step of reducing the molecular weight of a raw material starch having an amylose content of equal to or more than 5% by mass to obtain a low molecular weight starch having a peak molecular weight of equal to or more than 3×10³ and equal to or less than 5×10⁴.

(Granulation) A step of heating and gelatinizing a raw material which includes equal to or more than 3% by mass and equal to or less than 45% by mass of the low molecular weight starch, and in which the sum of the low molecular weight starch and the starch other than the low molecular weight starch is equal to or more than 75% by mass, and then granulating the raw material.

The preparing a low molecular weight starch is degrading a starch having an amylose content of equal to or more than 5% by mass into a low molecular weight starch. The term degrading as used herein refers to degradation involving molecular weight reduction of starch, and representative examples of the degradation method include degradation by an acid treatment, an oxidation treatment, and an enzymatic treatment. Among these, an acid treatment is preferred from the viewpoints of the degradation rate, cost, and reproducibility of the degradation reaction.

Furthermore, in the granulation step, any general method used for granulation of starch can be used; however, from the viewpoint of acquiring a predetermined degree of swelling in cold water, it is preferable to use a general method that is used for heating and gelatinization of starch. Specifically, methods of using machines such as a drum dryer, a jet cooker, an extruder, and a spray dryer are known; however, according to the present embodiment, from the viewpoint of more reliably obtaining a component (A) in which the degree of swelling in cold water satisfies the above-mentioned specific conditions, heating and gelatinization by an extruder or a drum dryer is preferred, and an extruder is more preferred.

In the case of performing an extruder treatment, usually, water is added to the raw material containing starch to adjust the water content to about 10% to 60% by mass, and then the raw material is heated and caused to swell under the conditions of, for example, a barrel temperature of 30° C. to 200° C., an outlet temperature of 80° C. to 180° C., a speed of screw rotation of 100 to 1,000 rpm, and a heat treatment time of 5 to 60 seconds.

According to the present embodiment, for example, by heating and gelatinizing a specific raw material, a component (A) in which the degree of swelling in cold water satisfies a specific condition can be obtained. Furthermore, the component (A) may be obtained by pulverizing and sieving the granulation product obtained by heating and gelatinization as necessary, and appropriately adjusting the size.

The content of the component (A) in the bakery dough according to the present embodiment is equal to or more than 0.5% by mass and equal to or less than 30% by mass with respect to the total content of a powder raw material, from the viewpoint of reducing stickiness and enhancing the melt-in-the-mouth feeling, easiness to bite, and soft feeling, and the content is preferably equal to or more than 0.7% by mass and equal to or less than 25% by mass, more preferably equal to or more than 0.9% by mass and equal to or less than 20% by mass, and even more preferably equal to or more than 1% by mass and equal to or less than 15% by mass.

From a similar point of view, the content of the component (A) in the bakery dough is equal to or more than 0.5% by mass with respect to the total content of the powder raw material, and the content is preferably equal to or more than 0.7% by mass, more preferably equal to or more than 0.9% by mass, even more preferably equal to or more than 1% by mass, and still more preferably equal to or more than 6% by mass, and while the content is equal to or less than 30% by mass, preferably equal to or less than 25% by mass, more preferably equal to or less than 20% by mass, and even more preferably equal to or less than 15% by mass.

The content of the component (A) in the bakery dough according to the present embodiment is, for example, equal to or more than 0.3% by mass and equal to or less than 25% by mass with respect to the total content of the dough, from the viewpoint of reducing stickiness and enhancing the melt-in-the-mouth feeling, easiness to bite, and soft feeling, and the content is preferably equal to or more than 0.4% by mass and equal to or less than 20% by mass, more preferably equal to or more than 0.5% by mass and equal to or less than 15% by mass, and even more preferably equal to or more than 0.6% by mass and equal to or less than 10% by mass.

From a similar point of view, the content of the component (A) in the bakery dough, the content of the component (A) in the bakery dough is, for example, equal to or more than 0.3% by mass with respect to the total content of the dough, and the content is preferably 0.4% by mass, more preferably equal to or more than 0.5% by mass, even more preferably equal to or more than 0.6% by mass, and still more preferably equal to or more than 4% by mass, and the content is, for example, equal to or less than 25% by mass, preferably equal to or less than 20% by mass, more preferably equal to or less than 15% by mass, even more preferably equal to or less than 10% by mass, and still more preferably equal to or less than 5% by mass.

The content of the component (A) with respect to the content of the edible fat or oil composition in the bakery dough according to the present embodiment is equal to or more than 0.03 and equal to or less than 8.0 as a mass ratio, and from the viewpoint of reducing stickiness and enhancing the melt-in-the-mouth feeling and easiness to bite, the content is preferably equal to or more than 0.1 and equal to or less than 5.0, more preferably equal to or more than 0.2 and equal to or less than 3.0, even more preferably equal to or more than 0.24 and equal to or less than 2.5, and still more preferably equal to or more than 0.27 and equal to or less than 1.5.

From a similar point of view, the content of the component (A) with respect to the content of the edible fat or oil composition in the bakery dough is equal to or more than 0.03 as a mass ratio, and the content is preferably equal to or more than 0.1, more preferably equal to or more than 0.2, even more preferably equal to or more than 0.24, and still more preferably equal to or more than 0.27, and the content is, for example, equal to or less than 8.0, preferably equal to or less than 5.0, more preferably equal to or less than 3.0, even more preferably equal to or less than 2.5, still more preferably equal to or less than 1.5, and even more preferably equal to or less than 0.7.

The component (A) obtainable as described above is a starch composition including a low molecular weight starch, and since the composition has a configuration in which the starch content, the degree of swelling in cold water, the peak molecular weight of the low molecular weight starch and the particle size all satisfy specific conditions, texture of the bakery food can be enhanced.

(Powder Raw Material)

Next, the powder raw material will be described. The powder raw material is a raw material that is blended in a powdery form into the bakery dough.

Specific examples of the powder raw material other than the component (A) in the bakery dough include grain flours such as wheat flour, rice flour, rye flour, and soybean flour; proteins such as gluten and soybean protein; polysaccharides such as unprocessed starch, esterified starch, etherified starch, pregelatinized starch, indigestible starch, and dextrin; sugars such as sugar, fructose, glucose, isomerized sugar, converted sugar, an oligosaccharide, trehalose, and a sugar alcohol; powdered sweeteners such as aspartame and acesulfame potassium; milks such as skimmed milk powder, whole milk powder, and cheese powder; table salt; dietary fibers such as bran, cellulose, and indigestible dextrin; eggs such as egg white powder and whole egg powder; thickening polysaccharides such as guar gum and an alginic acid ester; emulsifiers; flavor powders such as cocoa powder and powdered tea; improvers; and leavening agents.

In addition, the bakery dough preferably contains grain flour as the powder raw material, more preferably contains one kind or two or more kinds selected from wheat flour and rice flour, and even more preferably contains wheat flour.

(Edible Fat or Oil Composition)

The bakery dough according to the present embodiment contains an edible fat or oil composition. The solid fat content (SFC) at 20° C. of an edible fat or oil included in the edible fat or oil composition is equal to or less than 5%, preferably equal to or less than 3%, and more preferably 0%. Furthermore, the lower limit of the solid fat content at 20° C. in the edible fat or oil composition may be, for example, equal to or more than 0%.

The solid fat content (SFC) at 10° C. of an edible fat or oil included in the edible fat or oil composition is, for example, equal to or less than 5%, preferably equal to or less than 3%, and more preferably 0%. Furthermore, the lower limit of the solid fat content at 10° C. of the edible fat or oil included in the edible fat or oil composition may be, for example, equal to or more than 0%. The solid fat content of an edible fat or oil can be measured according to METHOD I described in AOCS Official Method Cd 16b-93.

Furthermore, it is preferable that the edible fat or oil used in the edible fat or oil composition has a melting point (specifically, slip melting point) of lower than 0° C. Measurement of the slip melting point can be carried out according to Standard Fats and Oils Analysis Testing Method 2.2.4.2-1996.

Specific examples of the edible fat or oil include vegetable fats and oils such as olive oil, rapeseed oil, sesame oil, corn oil, soybean oil, cottonseed oil, rice oil, sunflower oil, safflower oil, peanut oil, perilla oil, flaxseed oil, palm oil, palm kernel oil, and coconut oil; animal fats and oils such as milk fat, beef tallow, and lard; and medium-chain fatty acid triglycerides, and processed fats and oils such as fractionated oils (fractionated soft oil of palm oil, medium melting point portion of palm oil, and the like), interesterified oil, and hydrogenated oil of the above-mentioned fats and oils, can be used. The edible fat or oil preferably includes vegetable fats and oils; more preferably includes one kind or two or more kinds of vegetable fats and oils selected from olive oil, rapeseed oil, sesame oil, corn oil, soybean oil, and fractionated palm oil; even more preferably includes one kind or two or more kinds selected from olive oil, rapeseed oil, corn oil, soybean oil, and palm olein; and still more preferably includes one kind or two or more kinds selected from olive oil, rapeseed oil, and palm olein.

According to the present embodiment, the content of the edible fat or oil in the edible fat or oil composition is preferably equal to or more than 70% by mass, more preferably equal to or more than 80% by mass, even more preferably equal to or more than 90% by mass, and still more preferably equal to or more than 95% by mass. Furthermore, according to the present embodiment, the content of the edible fat or oil in the edible fat or oil composition is, for example, equal to or less than 100% by mass.

Here, the content of the edible fat or oil in the edible fat or oil composition is the content of the edible fat or oil in the total amount of the edible fat or oil composition.

It is also preferable that the edible fat or oil composition is a liquid at 25° C.

The content of the edible fat or oil composition in the bakery dough according to the present embodiment is preferably equal to or more than 2% by mass and equal to or less than 45% by mass, more preferably equal to or more than 2.5% by mass and equal to or less than 40% by mass, even more preferably equal to or more than 3% by mass and equal to or less than 37% by mass, and still more preferably equal to or more than 3.8% by mass and equal to or less than 33% by mass, with respect to the total amount of the powder raw material, from the viewpoint of reducing stickiness and enhancing the melt-in-the-mouth feeling.

From a similar point of view, the content of the edible fat or oil composition in the bakery dough, the content of the edible fat or oil composition in the bakery dough is preferably equal to or more than 2% by mass, more preferably equal to or more than 2.5% by mass, even more preferably equal to or more than 3% by mass, still more preferably equal to or more than 3.8% by mass, and even more preferably equal to or more than 10% by mass, and also preferably equal to or less than 45% by mass, more preferably equal to or less than 40% by mass, even more preferably equal to or less than 37% by mass, still more preferably equal to or less than 33% by mass, and even more preferably equal to or less than 25% by mass, with respect to the total amount of the powder raw material.

Furthermore, the content of the edible fat or oil composition with respect to the total amount of the bakery dough according to the present embodiment is preferably equal to or more than 1% by mass and equal to or less than 25% by mass, more preferably equal to or more than 1.3% by mass and equal to or less than 22% by mass, even more preferably equal to or more than 1.6% by mass and equal to or less than 20% by mass, and still more preferably equal to or more than 1.9% by mass and equal to or less than 18% by mass, from the viewpoint of reducing stickiness and enhancing the melt-in-the-mouth feeling.

From a similar point of view, the content of the edible fat or oil composition in the total amount of the bakery dough is preferably equal to or more than 1% by mass, more preferably equal to or more than 1.3% by mass, even more preferably equal to or more than 1.6% by mass, still more preferably equal to or more than 1.9% by mass, and even more preferably equal to or more than 5% by mass, and the content is preferably equal to or less than 25% by mass, more preferably equal to or less than 22% by mass, even more preferably equal to or less than 20% by mass, still more preferably equal to or less than 18% by mass, and even more preferably equal to or less than 15% by mass.

According to the present embodiment, the edible fat or oil composition may include components other than the edible fat or oil in accordance with the type of the bakery food, and specific examples of such components include a flavor, an emulsifier, and a coloring agent. The water content in the edible fat or oil composition may be 0% by mass. When the edible fat or oil composition includes water, the water content in the edible fat or oil composition is preferably more than 0% by mass and equal to or less than 1% by mass.

The component (A) that is obtained as described above and the edible fat or oil composition are added to obtain a bakery dough. In the preparing a bakery dough, the timing of adding the component (A) and the edible fat or oil composition is not limited, and the component (A), the edible fat or oil composition, and other raw materials may be mixed altogether at the same time, or the component (A) and the powder raw material may be mixed first, the resulting mixture being subsequently mixed with the edible fat or oil composition and other liquid raw materials. Furthermore, it is also effective as an aspect of the present embodiment to mix a mix powder obtained by mixing any of the component (A) and the powder raw material with the other raw materials.

The method for preparing a dough may be any method that is generally used, and examples include, in the case of bread dough, a direct kneading method (straight method), a sponge and dough method, a partial fermentation method, a sweetened sponge and dough method, a Poolish method (also known as Pâte fermentèe, liquid pre-ferment or liquid sponge), a no-time method, and the like.

In a case where there are two kinds of dough of a sponge dough and a main kneaded dough as in a sponge and dough method, the component (A) and the edible fat or oil composition may be blended into either or both of the sponge dough and the main kneaded dough; however, it is preferable to blend the component (A) and the edible fat or oil composition into the main kneaded dough.

Furthermore, the dough thus prepared may be stored frozen as a frozen dough.

The bakery dough prepared in this way is subjected to a process of heating cooking, and thus a bakery food can be obtained. Specific examples of the method of heating cooking include baking, steaming, steam convection heating, and deep frying, and one kind or two kinds of heating cooking selected from baking and deep frying are preferred, while baking in an oven is more preferred. The heating cooking temperature is preferably 150° C. to 260° C., and more preferably 160° C. to 250° C. The time is preferably 4 to 60 minutes, and more preferably 6 to 50 minutes.

The bakery dough may contain a fat or oil product other than the above-mentioned edible fat or oil composition according to the present embodiment, as a raw material. Specific examples of such a fat or oil product include margarine, shortening, and butter, which are generally used in bakery foods.

Furthermore, preferably, the bakery dough according to the present embodiment does not contain a fat or oil product other than the edible fat or oil composition according to the present embodiment.

(Other Components)

According to the present embodiment, the bakery dough may contain components other than the above-mentioned components, as raw materials. Regarding specific examples of the components other than the above-mentioned components, liquid components such as water, milk, soy milk, fruit juice, vegetable juice, honey, brown sugar syrup, and liquid sugar; eggs such as whole egg, egg yolk, and egg white; various flavor materials such as nuts, dry fruits, and chocolate chips; sesame; brown rice; and cereals such as millet and foxtail millet, can also be blended.

(Bakery Food)

Examples of the bakery food obtainable in the present embodiment include yeast-fermented foods such as bread, pizza, yeast doughnut, Chinese steamed bun, nan, and Danish pastry; yeast-free foods such as steamed bread, cake doughnut, and scone; and baked confectioneries such as pound cake, sponge cake, chiffon cake, roll cake, butter cake, muffin, cupcake, pancake, financier, bouchee, waffle, madeleine, and pie, and the bakery food is preferably bread, pizza, doughnut, Chinese steamed bun, nan, or Danish pastry; more preferably one selected from bread, pizza, and doughnut; and even more preferably bread.

The method according to the present embodiment for enhancing the easiness to bite a bakery food which is obtained by heating cooking a bakery dough blended with an edible fat or oil composition including an edible fat or oil having a solid fat content at 20° C. of equal to or less than 5%, is a method in which with regard to the bakery dough, a component (A) that satisfies the following conditions (1) to (4) is blended into the dough,

the blending amount of the component (A) in the dough of the bakery food is equal to or more than 0.5% by mass and equal to or less than 30% by mass with respect to the total blending amount of the powder raw material, and

the blending amount of the component (A) with respect to the blending amount of the edible fat or oil composition in the dough of the bakery food is equal to or more than 0.03 and equal to or less than 8.0 as a mass ratio:

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) the degree of swelling in cold water at 25° C. is equal to or higher than 5 and equal to or lower than 20, and

(4) a content of particles passing through a sieve having an opening of 0.5 mm and remaining on a sieve having an opening of 0.038 mm is equal to or more than 30% by mass and equal to or less than 100% by mass.

### EXAMPLES

(Raw Materials)

In the following examples, the following materials were mainly used as raw materials.

(Starch)

Acid-treated starch: Acid-treated high amylose cornstarch produced in Production Example 1 that will be described later.

Cornstarch: Cornstarch Y, manufactured by J-Oil Mills, Inc.

Starch compositions 1 to 4: Starch compositions produced by the method of Production Example 2 that will be described later.

(Edible Fat or Oil)

Edible fat or oil 1: AJINOMOTO Olive Oil Extra Virgin, manufactured by J-Oil Mills, Inc. (water content less than 1% by mass, slip melting point lower than 0° C.) Edible fat or oil 2: Rapeseed oil, manufactured by J-Oil Mills, Inc. (water content less than 1% by mass, slip melting point lower than 0° C.)

(Edible Fat or Oil Composition)

Edible fat or oil composition 1: 100% of edible fat or oil 1

Edible fat or oil composition 2: 100% of edible fat or oil 2

Edible fat or oil composition 3: A blend of edible fat or oil 2 and butter flavor (edible fat or oil content equal to or more than 98%)

(Powder Raw Material Other than Component (A))

Strong flour: EAGLE, manufactured by Nippon Flour Mills Co., Ltd.

Flour exclusive for French bread: Lis d'Or, manufactured by Nisshin Flour Milling, Inc.

Cocoa: VAN HOUTEN Cocoa Powder-RED, manufactured by Van Houten Pte. Ltd.

Improver: MAX POWER, manufactured by J-Oil Mills, Inc.

Instant dry yeast: SAF-INSTANT DRY YEAST RED, manufactured by LeSaffre Group

Skimmed milk powder: Skimmed milk powder, manufactured by Hokkaido Dairy Products Co., Ltd.

Sugar: Caster sugar, manufactured by Mitsui Sugar Co., Ltd.

(Others)

Fresh yeast: ORIENTAL YEAST FD-1, shape: paste form, manufactured by Oriental Yeast Co., Ltd.

### (Production Example 1) Production of Acid-Treated Starch

An acid-treated starch was produced as a low molecular weight starch that served as a raw material for starch compositions 1 to 4.

(Method for Producing Acid-Treated High Amylose Cornstarch)

High amylose cornstarch (manufactured by J-Oil Mills, Inc., HS-7, amylose content 70% by mass) was suspended in water to prepare a 35.6% (w/w) slurry, and the slurry was heated to 50° C. An aqueous solution of hydrochloric acid prepared at 4.25 N was added to the slurry with stirring, the amount of the aqueous solution being 1/9 times as a slurry mass ratio, and a reaction was initiated. After the reaction was performed for 16 hours, the reaction mixture was neutralized with 3% NaOH, washed with water, dehydrated, and dried to obtain an acid-treated high amylose cornstarch.

The peak molecular weight of the acid-treated high amylose cornstarch thus obtained was measured by the method described below, and the peak molecular weight was 1.2×10⁴.

(Method for Measuring Peak Molecular Weight)

The measurement of the peak molecular weight was carried out using an HPLC unit manufactured by Tosoh Corporation (pump DP-8020, RI detector RS-8021, degassing apparatus SD-8022).

(1) A sample was pulverized, and a fraction of particles passing through a sieve having an opening of 0.15 mm was collected with the sieves of the JIS-Z8801-1 standard. This collected fraction was suspended in a mobile phase at a concentration of 1 mg/mL, and the suspension was heated at 100° C. for 3 minutes to completely dissolve. Filtration was performed using a 0.45-μm filtration filter (manufactured by ADVANTEC MFS, Inc., DISMIC-25HP PTFE 0.45 μm), and the filtrate was used as an analysis sample.

(2) The molecular weight was measured under the following analytical conditions.

Column: Two units of TSKgel α-M (7.8 mmφ, 30 cm) (manufactured by Tosoh Corporation)

Flow rate: 0.5 mL/min

Mobile phase: 5 mM sodium nitrate-containing 90% (v/v) dimethyl sulfoxide solution, Column temperature: 40° C.

Analysis amount: 0.2 mL

(3) Detector data was collected using software (MULTISTATION GPC-8020 model II data collection ver5.70, manufactured by Tosoh Corporation), and the molecular weight peak was calculated.

For the calibration curve, pullulans having known molecular weights (Shodex Standard P-82, manufactured by Showa Denko K.K.) was used.

(Method for Measuring Degree of Swelling in Cold Water)

(1) A sample was heated and dried at 125° C., the moisture content was measured using a moisture meter (Kensei Kogyo Co., Ltd., model number MX-50), and the dried substance mass was calculated from the moisture content value thus obtained.

(2) 1 g of the sample in terms of this dried substance mass was dispersed in 50 mL of water at 25° C., the dispersion was stirred gently in a constant temperature bath at 25° C. for 30 minutes, and then the dispersion was centrifuged (centrifugal separator: manufactured by Hitachi Koki Co., Ltd., Hitachi Tabletop Centrifuge CT6E type; rotor: T4SS type swing rotor; adapter: 50TC×2S adapter) at 3000 rpm for 10 minutes to be separated into a sediment layer and a supernatant layer.

(3) The supernatant layer was removed, the mass of the sediment layer was measured, and this was designated as B (g).

(4) The mass obtained when the sediment layer was solid-dried (105° C., constant weight) was designated as C (g).

(5) The value obtained by dividing B by C was defined as the degree of swelling in cold water.

### (Production Example 2) Production of Starch Compositions 1 to

79% by mass of cornstarch, 20% by mass of an acid-treated high amylose cornstarch obtained by the above-described method, and 1% by mass of calcium carbonate were mixed in a bag until the mixture became sufficiently uniform. The mixture was heat-treated under pressure using a twin-screw extruder (KEI-45 manufactured by Kowa Kogyo, Inc.). The processing conditions are as follows.

Raw material supply: 450 g/min

Added water: 17% by mass

Barrel temperature: 50° C., 70° C., and 100° C. increasing from the raw material inlet port toward the outlet port

Outlet temperature: 100° C. to 110° C.

Speed of screw rotation: 250 rpm

The heating and gelatinization product obtained by an extruder treatment in this manner was dried at 110° C. to adjust the water content to 10% by mass.

Next, the dried heating and gelatinization product was pulverized with a tabletop cutter crusher, and then the pulverization product was sieved with sieves of the JIS-Z8801-1 standard. The sieved heating and gelatinization product was mixed at the blending proportions shown in Table 1, and starch compositions 1 to 4 were prepared. The values obtained by measuring the degree of swelling in cold water at 25° C. of the starch compositions 1 to 4 by the above-mentioned method are collectively shown in Table 1.

TABLE 1

| | Starch | Starch | Starch | Starch |
|---|---|---|---|---|
| Fraction (mass %) | composition 1 | composition 2 | composition 3 | composition 4 |
| Particles below 1 mm and above | 18.0 | | | |
| 0.5 mm | | | | |
| Particles below 0.5 mm and above | 42.0 | | | |
| 0.25 mm | | | | |
| Particles below 0.25 mm and | 15.0 | 36.4 | | |
| above 0.15 mm | | | | |
| Particles below 0.15 mm and | 20.0 | 48.0 | 75.5 | |
| above 0.075 mm | | | | |
| Particles below 0.075 mm and | 3.7 | 11.4 | 17.9 | 73.1 |
| above 0.038 mm | | | | |
| Particles below 0.038 mm | 1.3 | 4.2 | 6.6 | 26.9 |
| Sum of fractions (mass %) | 100.0 | 100.0 | 100.0 | 100.0 |
| Fraction of particles below 0.5 | 80.7 | 95.8 | 93.4 | 73.1 |
| mm and above 0.038 mm (mass %) | | | | |
| Fraction of particles below 0.25 | 38.7 | 95.8 | 93.4 | 73.1 |
| mm and above 0.038 mm (mass %) | | | | |
| Fraction of particles below 0.15 | 23.7 | 59.4 | 93.4 | 73.1 |
| mm and above 0.038 mm (mass %) | | | | |
| Degree of swelling in cold water | 10.5 | 7.3 | 9.5 | 8.5 |

Note) For example, “particles below 3.35 mm and above 1.4 mm” means “particles passing through a sieve having an opening of 3.35 mm and remaining on a sieve having an opening of 1.4 mm according to the JIS-Z8801-1 standard”.

Table 2 shows below the solid fat contents (SFC) of the edible fats and oils included in the edible fats and oils 1 and 2.

(Method for Measuring SFC) The solid fat content (SFC) (%) was measured according to AOCS Official Method Cd 16b-93 METHOD I.

(Method for Measuring Slip Melting Point)

For the edible fats and oils 1 and 2, the slip melting points were measured according to Standard Fats and Oils Analysis Testing Method 2.2.4.2-1996.

TABLE 2

| Type of edible fat or oil | SFC at 20° C. (%) | SFC at 10° C. (%) |
|---|---|---|
| Edible fat or oil 1 | 0 | 0 |
| Edible fat or oil 2 | 0 | 0 |

(Method for Producing Cocoa Bread Containing Edible Fat or Oil Composition)

Doughs were prepared according to the blends shown in Tables 3 to 5.

1. All the materials including an edible fat or oil composition were put into a mixer bowl, and the mixture was mixed with a bread mixer (KANTO MIXER HP-20M, manufactured by Kanto Kongoki Industrial Co., Ltd.) under the following conditions. However, only in Examples 5 and 6, the powder raw material was first mixed in a plastic bag to produce a mix powder, subsequently the mix powder was put into a mixer bowl, the remaining materials were further put into the mixer bowl, and mixing was performed under the following conditions.

Mixing conditions: Kneading for 3 minutes at Speed 1 and for 16 minutes at Speed 2 using a hook.

2. After mixing, the dough was taken out of the mixer and was fermented at 28° C. for 60 minutes.

3. The dough was divided into 50-g portions, rolled, allowed to rest for 20 minutes, and then formed by rounding.

4. The formed dough pieces were fermented in a proofer at 36° C. and a relative humidity of 75% for 70 minutes.

5. After fermentation, the dough pieces were baked in an oven under the following conditions and time.

Baking conditions: Upper row 220° C./lower row 180° C.

Baking time: 10 minutes

6. After baking, the baked bread was cooled down at room temperature (20° C.)

(Method for Producing Rustique (a Kind of French Bread) Containing Edible Fat or Oil Composition)

A dough was prepared as follows according to the blend shown in Table 6.

1. All the materials including an edible fat or oil composition were put into a mixer bowl and mixed with a bread mixer (KANTO MIXER HP-20M, manufactured by Kanto Kongoki Industrial Co., Ltd.).

Mixing conditions: Kneading for 4 minutes at Speed 1 and for 4 minutes at Speed 2 using a hook

2. After mixing, the dough was taken out of the mixer, fermented at 28° C. for 60 minutes, and punched.

3. The dough was fermented for another 30 minutes and punched for the second time. The dough was fermented again for another 30 minutes.

4. The dough was divided into 120-g portions, and the pieces were arranged on a canvas as they were.

5. The dough pieces arranged on the canvas were fermented in a proofer at 36° C. and a relative humidity of 75% for 40 minutes.

6. After fermentation, the dough pieces were baked in an oven under the following conditions and time.

Baking conditions: Upper row 220° C./lower row 220° C.

Baking time: 25 minutes

7. After baking, the baked bread was cooled down at room temperature (20° C.)

(Evaluation Methods)

In the following description, the breads produced in the various examples were evaluated in terms of the melt-in-the-mouth feeling and stickiness, easiness to bite, and soft feeling by four expert panelists according to the following evaluation criteria. The average value of the scores given by the four people was calculated, and a score of equal to or higher than 1.5 was regarded as a pass.

The evaluation criteria are shown below.

(Melt-in-the-mouth feeling and stickiness)

3: Very good melt-in-the-mouth feeling and not sticky at all.

2: Good melt-in-the-mouth feeling and almost not sticky.

1: Poor melt-in-the-mouth feeling and sticky.

(Easiness to Bite)

3: Very easy to bite.

2: Easy to bite.

1: Not so easy to bite.

(Soft Feeling)

3: Very soft.

2: Soft.

1: Slight hardness is felt.

(Experiment 1)

A dough was prepared by the above-described method using the raw materials described in Table 3 and was baked to produce bread, and the bread was evaluated.

The evaluation results are shown in Table 3.

TABLE 3

| | | Control | | | | | | |
|---|---|---|---|---|---|---|---|---|
| Powder raw material | Raw material (parts by mass) | example | Example 1 | Example 2 | Example 3 | Example 4 | Example 5 | Example 6 |
| ◯ | Strong flour | 100 | 100 | 100 | 100 | 100 | 100 | 100 |
| ◯ | Sugar | 15 | 15 | 15 | 15 | 15 | 15 | 15 |
| ◯ | Salt | 1.8 | 1.8 | 1.8 | 1.8 | 1.8 | 1.8 | 1.8 |
| ◯ | Skimmed milk powder | 3 | 3 | 3 | 3 | 3 | 3 | 3 |
| ◯ | Cocoa | 3 | 3 | 3 | 3 | 3 | 3 | 3 |
| ◯ | Improver | 0.5 | 0.5 | 0.5 | 0.5 | 0.5 | 0.5 | 0.5 |
| ◯ | Component (A): starch composition 1 | | 6 | 10 | 15 | | | |
| ◯ | Component (A): starch composition 2 | | | | | 5 | | |
| ◯ | Component (A): starch composition 3 | | | | | | 3 | |
| ◯ | Component (A): starch composition 4 | | | | | | | 1.5 |
| | Edible fat or oil composition 1 | 30 | 30 | 30 | 30 | 30 | 30 | 30 |
| | Fresh yeast | 4 | 4 | 4 | 4 | 4 | 4 | 4 |
| | Water | 49 | 58 | 64 | 72 | 56 | 54 | 52 |

| | | | | | | | |
|---|---|---|---|---|---|---|---|
| Total powder raw material | 123.3 | 129.3 | 133.3 | 138.3 | 128.3 | 126.3 | 124.8 |
| Total dough | 206.3 | 221.3 | 231.3 | 244.3 | 218.3 | 214.3 | 210.8 |
| Component (A)/edible fat or oil composition mass ratio* | 0.00 | 0.20 | 0.33 | 0.50 | 0.17 | 0.10 | 0.05 |
| Edible fat or oil composition/powder raw material mass %** | 24.3 | 23.2 | 22.5 | 21.7 | 23.4 | 23.8 | 24.0 |
| Edible fat or oil composition/dough mass %*** | 14.5 | 13.6 | 13.0 | 12.3 | 13.7 | 14.0 | 14.2 |
| Component (A)/powder raw material mass %**** | — | 4.64 | 7.50 | 10.85 | 3.90 | 2.38 | 1.20 |
| Component (A)/dough mass %***** | — | 2.71 | 4.32 | 6.14 | 2.29 | 1.40 | 0.71 |
| Sensory evaluation | | | | | | | |
| Melt-in-the-mouth feeling/stickiness | 1.00 | 1.50 | 2.00 | 2.25 | 1.50 | 1.75 | 1.75 |
| Easiness to bite | 1.00 | 1.50 | 2.25 | 2.75 | 1.75 | 2.00 | 2.00 |
| Soft feeling | 1.00 | 1.50 | 2.00 | 2.50 | 1.75 | 2.00 | 2.00 |

Remarks)
*Component (A)/edible fat or oil composition means the mass ratio of the component (A) with respect to the edible fat or oil composition.
**Edible fat or oil composition/powder raw material (mass %) means the percentage by mass of the edible fat or oil composition with respect to the total amount of the powder raw material.
***Edible fat or oil composition/dough (mass %) means the percentage by mass of the edible fat or oil composition with respect to the total amount of the dough.
****Component (A)/powder raw material (mass %) means the percentage by mass of the component (A) with respect to the total amount of the powder raw material.
*****Component (A)/dough (mass %) means the percentage by mass of the component (A) with respect to the total amount of the dough.

From Table 3, the breads containing the edible fat or oil composition 1 and predetermined amounts of the starch compositions 1 to 4 as the component (A) all had excellent mouthfeel as compared with a control example.

In terms of the melt-in-the-mouth feeling and stickiness, easiness to bite, and soft feeling of the breads, these characteristics were satisfactory when the blending amount of the component (A) with respect to the powder raw material was equal to or more than 4.64% by mass and equal to or less than 10.85% by mass, and were more satisfactory when the blending amount was equal to or more than 7.50% by mass and equal to or less than 10.85% by mass (comparison of Examples 1 to 3).

Furthermore, in terms of the melt-in-the-mouth feeling and stickiness, easiness to bite, and soft feeling of the breads thus obtained, these characteristics were satisfactory when the blending amount of the component (A) with respect to the total dough was equal to or more than 2.71% by mass and equal to or less than 6.14% by mass, and were more satisfactory when the blending amount was equal to or more than 4.32% by mass and equal to or less than 6.14% by mass (comparison of Examples 1 to 3).

When the content of particles passing through a sieve having an opening of 0.5 mm and remaining on a sieve having an opening of 0.038 mm in the component (A) was equal to or more than 73.1% by mass and equal to or less than 95.8% by mass, the melt-in-the-mouth feeling and stickiness, easiness to bite, and soft feeling of the breads thus obtained were excellent.

Furthermore, in a case where the content of particles passing through a sieve having an opening of 0.25 mm and remaining on a sieve having an opening of 0.038 mm in the component (A) was equal to or more than 38.7% by mass and equal to or less than 95.8% by mass, the melt-in-the-mouth feeling and stickiness, easiness to bite, and soft feeling of the breads thus obtained were excellent.

In addition, when the content of particles passing through a sieve having an opening of 0.15 mm and remaining on a sieve having an opening of 0.038 mm in the component (A) was equal to or more than 23.7% by mass and equal to or less than 93.4% by mass, the breads thus obtained were excellent from the viewpoint of the melt-in-the-mouth feeling and stickiness. From the viewpoint of easiness to bite and soft feeling, the breads were excellent when the content was equal to or more than 23.7% by mass and equal to or less than 93.4% by mass.

When compared with the starch composition 1 in which the content of particles passing through a sieve having an opening of 0.15 mm and remaining on a sieve having an opening of 0.038 mm in the component (A) was 23.7% by mass, the starch compositions 2 to 4 in which the content of particles passing through a sieve having an opening of 0.15 mm and remaining on a sieve having an opening of 0.038 mm in the component (A) was equal to or more than 59.4% by mass and equal to or less than 93.4% by mass, resulted in excellent melt-in-the-mouth feeling and sticky sensation, easiness to bite, and soft feeling of the obtained breads, even with smaller amounts of addition of the starch compositions. Here, the starch compositions 3 and 4 tended to easily generate some lumps when the starch compositions were mixed with materials during the bread production process.

(Experiment 2)

Bread was produced and evaluated by the same procedure as in Experiment 1, except that the blending ratios of the raw materials were adjusted as shown in Table 4.

The various evaluation results are collectively shown in Table 4.

TABLE 4

| | | Control | | | | | |
|---|---|---|---|---|---|---|---|
| Powder raw material | Raw material (parts by mass) | example | Example 7 | Example 8 | Example 9 | Example 2 | Example 10 |
| ◯ | Strong flour | 100 | 100 | 100 | 100 | 100 | 100 |
| ◯ | Sugar | 15 | 15 | 15 | 15 | 15 | 15 |
| ◯ | Salt | 1.8 | 1.8 | 1.8 | 1.8 | 1.8 | 1.8 |
| ◯ | Skimmed milk powder | 3 | 3 | 3 | 3 | 3 | 3 |
| ◯ | Cocoa | 3 | 3 | 3 | 3 | 3 | 3 |
| ◯ | Improver | 0.5 | 0.5 | 0.5 | 0.5 | 0.5 | 0.5 |
| ◯ | Component(A): starch composition 1 | | 10 | 10 | 10 | 10 | 10 |
| | Edible fat or oil composition 1 | 25 | 10 | 20 | 25 | 30 | 40 |
| | Fresh yeast | 4 | 4 | 4 | 4 | 4 | 4 |
| | Water | 55 | 82 | 75 | 72 | 64 | 60 |

| | | | | | | |
|---|---|---|---|---|---|---|
| Total powder raw material | 123.3 | 133.3 | 133.3 | 133.3 | 133.3 | 133.3 |
| Total dough | 207.3 | 229.3 | 232.3 | 234.3 | 231.3 | 237.3 |
| Component (A)/edible fat or oil composition mass ratio* | 0.00 | 1.00 | 0.50 | 0.40 | 0.33 | 0.25 |
| Edible fat or oil composition/powder raw material mass %** | 20.3 | 7.5 | 15.0 | 18.8 | 22.5 | 30.0 |
| Edible fat or oil composition/dough mass %*** | 12.1 | 4.4 | 8.6 | 10.7 | 13.0 | 16.9 |
| Component (A)/powder raw material mass %**** | — | 7.50 | 7.50 | 7.50 | 7.50 | 7.50 |
| Component (A)/dough mass %***** | — | 4.36 | 4.30 | 4.27 | 4.32 | 4.21 |
| Sensory evaluation | | | | | | |
| Melt-in-the-mouth feeling/stickiness | 1.00 | 1.75 | 2.25 | 2.25 | 2.00 | 2.00 |
| Easiness to bite | 1.00 | 1.50 | 2.25 | 2.25 | 2.25 | 2.00 |
| Soft feeling | 1.00 | 1.50 | 1.50 | 1.75 | 2.00 | 2.75 |

Remarks)
*Component (A)/edible fat or oil composition means the mass ratio of the component (A) with respect to the edible fat or oil composition.
**Edible fat or oil composition/powder raw material (mass %) means the percentage by mass of the edible fat or oil composition with respect to the total amount of the powder raw material.
***Edible fat or oil composition/dough (mass %) means the percentage by mass of the edible fat or oil composition with respect to the total amount of the dough.
****Component (A)/powder raw material (mass %) means the percentage by mass of the component (A) with respect to the total amount of the powder raw material.
*****Component (A)/dough (mass %) means the percentage by mass of the component (A) with respect to the total amount of the dough.

As shown in Table 4, the breads containing the edible fat or oil composition 1 and a predetermined amount of the starch composition 1 as the component (A) all had excellent mouthfeel.

The breads were satisfactory from the viewpoint of the melt-in-the-mouth feeling and stickiness when the mass ratio of the component (A) with respect to the fat or oil composition (that is, component (A)/edible fat or oil composition) was equal to or more than 0.25 and equal to or less than 1.0, more satisfactory when the mass ratio was equal to or more than 0.25 and equal to or less than 0.5, and even more satisfactory when the mass ratio was equal to or more than 0.4 and equal to or less than 0.5. From the viewpoint of enhancing easiness to bite, the breads were satisfactory when the ratio (component (A)/edible fat or oil composition) was equal to or more than 0.25 and equal to or less than 1.0, more satisfactory when the ratio was equal to or more than 0.25 and equal to or less than 0.5, and even more satisfactory when the ratio was equal to or more than 0.33 and equal to or less than 0.5. From the viewpoint of soft feeling, the breads were satisfactory when the ratio (component (A)/edible fat or oil composition) was equal to or more than 0.25 and equal to or less than 1.0, more satisfactory when the ratio was equal to or more than 0.25 and equal to or less than 0.4, and even more satisfactory when the ratio was equal to or more than 0.25 and equal to or less than 0.33.

Furthermore, from the viewpoint of the melt-in-the-mouth feeling and stickiness, the breads were satisfactory when the percentage by mass of the edible fat or oil composition in the bakery dough was equal to or more than 7.5% by mass and equal to or less than 30.0% by mass with respect to the total amount of the powder raw material, and more satisfactory when the percentage was equal to or more than 15.0% by mass and equal to or less than 18.8% by mass. From the viewpoint of enhancing easiness to bite, the breads were satisfactory when the percentage by mass of the edible fat or oil composition with respect to the total amount of the powder raw material was equal to or more than 7.5% by mass and equal to or less than 30.0% by mass, more satisfactory when the percentage was equal to or more than 15.0% by mass and equal to or less than 30.0% by mass, and even more satisfactory when the percentage was equal to or more than 15.0% by mass and equal to or less than 22.5% by mass. From the viewpoint of enhancing the soft feeling, the breads were satisfactory when the percentage by mass of the edible fat or oil composition with respect to the total amount of the powder raw material was equal to or more than 7.5% by mass and equal to or less than 30.0% by mass, more satisfactory when the percentage was equal to or more than 18.8% by mass and equal to or less than 30.0% by mass, and even more satisfactory when the percentage was equal to or more than 22.5% by mass and equal to or less than 30.0% by mass.

From the viewpoint of the melt-in-the-mouth feeling and stickiness, the breads were satisfactory when the percentage by mass of the edible fat or oil composition with respect to the total amount of the bakery dough was equal to or more than 4.4% by mass and equal to or less than 16.9% by mass, and more satisfactory when the percentage was equal to or more than 8.6% by mass and equal to or less than 10.7% by mass. From the viewpoint of enhancing easiness to bite, the breads were satisfactory when the percentage by mass of the edible fat or oil composition with respect to the total amount of the bakery dough was equal to or more than 4.4% by mass and equal to or less than 16.9% by mass, more satisfactory when the percentage was equal to or more than 8.6% by mass and equal to or less than 16.9% by mass, and even more satisfactory when the percentage was equal to or more than 8.6% by mass and equal to or less than 13.0% by mass. From the viewpoint of enhancing soft feeling, the breads were satisfactory when the percentage by mass of the edible fat or oil composition with respect to the total amount of the bakery dough was equal to or more than 4.4% by mass and equal to or less than 16.9% by mass, more satisfactory when the percentage was equal to or more than 10.7% by mass and equal to or less than 16.9% by mass, and even more satisfactory when the percentage was equal to or more than 13.0% by mass and equal to or less than 16.9% by mass.

(Experiment 3)

Breads were produced and evaluated by the same procedure as in Experiment 1, except that the blending ratios of the raw materials were adjusted as shown in Table 5.

The various evaluation results are collectively shown in Table 5.

TABLE 5

| Powder raw material | Raw material (parts by mass) | Example 11 | Example 12 |
|---|---|---|---|
| ◯ | Strong flour | 100 | 100 |
| ◯ | Sugar | 15 | 15 |
| ◯ | Salt | 1.8 | 1.8 |
| ◯ | Skimmed milk powder | 3 | 3 |
| ◯ | Cocoa | 3 | 3 |
| ◯ | Improver | 0.5 | 0.5 |
| ◯ | Component (A): starch composition 1 | 10 | 10 |
| | Edible fat or oil composition 1 | 20 | — |
| | Edible fat or oil composition 2 | — | 10 |
| | Edible fat or oil composition 3 | — | 10 |
| | Fresh yeast | 4 | 4 |
| | Water | 73 | 73 |

| | | |
|---|---|---|
| Total powder raw material | 133.3 | 133.3 |
| Total dough | 230.3 | 230.3 |
| Component (A)/edible fat or oil composition mass ratio* | 0.50 | 0.50 |
| Edible fat or oil composition/powder raw material mass %** | 15.0 | 15.0 |
| Edible fat or oil composition/dough mass %*** | 8.7 | 8.7 |
| Component (A)/powder raw material mass %**** | 7.50 | 7.50 |
| Component (A)/dough mass %***** | 4.34 | 4.34 |

Sensory evaluation

| | | |
|---|---|---|
| Melt-in-the-mouth feeling/stickiness | 2.25 | 2.25 |
| Easiness to bite | 2.25 | 2.25 |
| Soft feeling | 1.50 | 1.50 |

Remarks)
*Component (A)/edible fat or oil composition means the mass ratio of the component (A) with respect to the edible fat or oil composition.
**Edible fat or oil composition/powder raw material (mass %) means the percentage by mass of the edible fat or oil composition with respect to the total amount of the powder raw material.
***Edible fat or oil composition/dough (mass %) means the percentage by mass of the edible fat or oil composition with respect to the total amount of the dough.
****Component (A)/powder raw material (mass %) means the percentage by mass of the component (A) with respect to the total amount of the powder raw material.
*****Component (A)/dough (mass %) means the percentage by mass of the component (A) with respect to the total amount of the dough.

From Table 5, with regard to a bakery dough containing the component (A), even in a case where the edible fat or oil composition 2 and the edible fat or oil composition 3 were mixed at a ratio of 1:1 instead of the case where the edible fat or oil composition 1 was used, a bread in which stickiness was reduced and which had excellent melt-in-the-mouth feeling and easiness to bite as well as soft feeling was obtained, as in the case of the edible fat or oil composition 1.

(Experiment 4)

A dough was prepared by the above-described method using the blending ratio of the raw materials as described in Table 6, and a rustique was obtained.

TABLE 6

| Powder raw material | Raw material (parts by mass) | Example 13 |
|---|---|---|
| ◯ | Flour exclusive for French bread | 100 |
| ◯ | Salt | 2.1 |
| ◯ | Instant dry yeast | 0.5 |
| ◯ | Component (A): starch composition 1 | 10 |
| | Edible fat or oil composition 1 | 5 |
| | Water | 95 |

| | |
|---|---|
| Total powder raw material | 112.6 |
| Total dough | 212.6 |
| Component (A)/edible fat or oil composition mass ratio* | 2.00 |
| Edible fat or oil composition/powder raw material mass %** | 4.4 |
| Edible fat or oil composition/dough mass %*** | 2.4 |
| Component (A)/powder raw material mass %**** | 8.88 |
| Component (A)/dough mass %***** | 4.70 |

Remarks)
*Component (A)/edible fat or oil composition means the mass ratio of the component (A) with respect to the edible fat or oil composition.
**Edible fat or oil composition/powder raw material (mass %) means the percentage by mass of the edible fat or oil composition with respect to the total amount of the powder raw material.
***Edible fat or oil composition/dough (mass %) means the percentage by mass of the edible fat or oil composition with respect to the total amount of the dough.
****Component (A)/powder raw material (mass %) means the percentage by mass of the component (A) with respect to the total amount of the powder raw material.
*****Component (A)/dough (mass %) means the percentage by mass of the component (A) with respect to the total amount of the dough.

Even in a case where the type of bread was rustique, when the component (A) and the edible fat or oil composition were included, a bread in which stickiness was reduced and which had excellent melt-in-the-mouth feeling and easiness to bite as well as soft feeling was obtained.

This patent application claims priority on the basis of Japanese Patent Application No. 2018-226093, filed on Nov. 30, 2018, the disclosure of which is incorporated herein in its entirety by reference.

1. A method for producing a bakery food, the method comprising preparing a bakery dough containing: an edible fat or oil composition including an edible fat or oil having a solid fat content at 20° C. of equal to or less than 5%; and a component (A) satisfying the following conditions (1) to (4),
wherein in the preparing a bakery dough,
a content of the component (A) in the bakery dough is equal to or more than 0.5% by mass and equal to or less than 30% by mass with respect to a total content of a powder raw material, and
a content of the component (A) with respect to a content of the edible fat or oil composition in the bakery dough is equal to or more than 0.03 and equal to or less than 8.0 as a mass ratio,
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of particles passing through a sieve having an opening of 0.5 mm and remaining on a sieve having an opening of 0.038 mm is equal to or more than 30% by mass and equal to or less than 100% by mass.

2. The method for producing a bakery food according to claim 1, further comprising heating cooking the bakery dough.

3. The method for producing a bakery food according to claim 2, wherein a method for the heating cooking is baking or deep frying.

4. The method for producing a bakery food according to claim 1, wherein the bakery food is one selected from the group consisting of bread, pizza, and doughnut.

5. The method for producing a bakery food according to claim 1, wherein a content of particles passing through a sieve having an opening of 0.25 mm and remaining on a sieve having an opening of 0.038 mm in the component (A) is equal to or more than 20% by mass and equal to or less than 100% by mass.

6. The method for producing a bakery food according to claim 1, wherein the bakery dough contains grain flour.

7. The method for producing a bakery food according to claim 1, wherein a solid fat content at 10° C. of the edible fat or oil is equal to or less than 5%.

8. The method for producing a bakery food according to claim 1, wherein the content of the edible fat or oil composition in the bakery dough is equal to or more than 2% by mass and equal to or less than 45% by mass with respect to the total content of the powder raw material.

9. A bakery dough comprising: an edible fat or oil composition including an edible fat or oil having a solid fat content at 20° C. of equal to or less than 5%; and a component (A) satisfying the following conditions (1) to (4),
wherein a content of the component (A) in the bakery dough is equal to or more than 0.5% by mass and equal to or less than 30% by mass with respect to a total content of a powder raw material, and
a content of the component (A) with respect to a content of the edible fat or oil composition in the bakery dough is equal to or more than 0.03 and equal to or less than 8.0 as a mass ratio:
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of particles passing through a sieve having an opening of 0.5 mm and remaining on a sieve having an opening of 0.038 mm is equal to or more than 30% by mass and equal to or less than 100% by mass.

10. A method for enhancing easiness to bite a bakery food which is obtainable by heating cooking a bakery dough blended with an edible fat or oil composition including an edible fat or oil having a solid fat content at 20° C. of equal to or less than 5%,
wherein a component (A) satisfying the following conditions (1) to (4) is blended into the bakery dough,
a blending amount of the component (A) in the dough of the bakery food is equal to or more than 0.5% by mass and equal to or less than 30% by mass with respect to a total blending amount of a powder raw material, and
the blending amount of the component (A) with respect to a blending amount of the edible fat or oil composition in the bakery dough is equal to or more than 0.03 and equal to or less than 8.0 as a mass ratio:
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of particles passing through a sieve having an opening of 0.5 mm and remaining on a sieve having an opening of 0.038 mm is equal to or more than 30% by mass and equal to or less than 100% by mass.
